(19) United States
(12) Patent Application Publication
(10) Pub. No.: US 2013/0098529 A1
(43) Pub. Date: Apr. 25, 2013

(54) ELECTROMAGNETIC ENERGY CONCENTRATING DEVICE AND METHOD THEREFOR

(71) Applicant: SOUTHWEST SOLAR TECHNOLOGIES, INC., Phoenix, AZ (US)

(72) Inventors: Basset Brittingham, III, Highlands Ranch, CO (US); Zoltan Farkas, Chandler, AZ (US); Patrick K. Soliday, Littleton, CO (US)

(73) Assignee: SOUTHWEST SOLAR TECHNOLOGIES, INC., Phoenix, AZ (US)

(21) Appl. No.: 13/713,300

(22) Filed: Dec. 13, 2012

Related U.S. Application Data
(62) Division of application No. 12/538,051, filed on Aug. 7, 2009, now abandoned.

(51) Int. Cl. G02B 5/10

(52) U.S. Cl. CPC G02B 5/10
USPC 156/64

(57) ABSTRACT

An electromagnetic energy concentrating dish (22) that comprises a contoured polymeric support (62) and a reflective surface (60). A contour (26) is determined that will reflect electromagnetic energy from reflective surface (60) to a receiver (36) set at focus region (28). A net or near net polymeric foam (100) is machined to form contoured polymeric support (62) having contour (26′). Reflective surface (60) is laid upon contoured polymeric support (62), and angles of reflection from reflective surface (60) adjust to reflect electromagnetic energy to focus region (28).

CROSS REFERENCE TO RELATED APPLICATION[S]

This application is a divisional of the earlier U.S. Patent Application to Brittingham, III et al., entitled ELECTROMAGNETIC ENERGY CONCENTRATING DEVICE AND METHOD THEREFOR, Ser. No. 12/538,051, filed Aug. 7, 2009, the disclosure of which is hereby incorporated entirely herein by reference.

### TECHNICAL FIELD OF THE INVENTION

The present invention relates to the field of electromagnetic energy concentrating and/or collection devices. More specifically, the present invention relates to such devices that are suitable for large-scale implementation, both in size and quantity, and for methods of constructing such devices.

### BACKGROUND OF THE INVENTION

The Electromagnetic radiation energy concentrators have been used in many devices, including antennas for audio, video and data transmission, as well as electricity generating devices. As the size of these devices increases, the need for precise, efficient, light-weight concentrators increases. Furthermore, as these devices become larger, the costs associated with fabricating them increase greatly. The weight and wind loading of the concentrators increase as the size increases. This results in the need for a stronger structure to support the concentrator. As the strength of the support increases, the weight and cost associated with the manufacture of the support also increases. Thus, there is a need for low-cost, high-performance concentrators.

The efficiency of these devices is directly related to ability of the concentrators to concentrate reflected energy to a focus point, or at least within a small focus region. When using the concentrator to collect energy to convert to electricity, it is desirable to have a greater intensity of reflected electromagnetic energy. In such concentrators, higher efficiencies are typically achieved at higher levels of energy concentration; but achieving high levels of concentration typically requires a high degree of accuracy and precision in the formation of the concentrator. A higher degree of accuracy and precision typically entails greater expense, and this expense has conventionally increased as the size of the concentrator has increased. While the high expense associated with conventional large, highly concentrating concentrators may be tolerable for experimental and one-of-a-kind applications, such high expenses are completely intolerable for concentrators to be replicated many times in an assembly-line fashion to generate electrical energy on a scale that would be useful for large numbers of people.

In the 1970's and 1980's, there were developments aimed towards creating glass reflector designs for electromagnetic radiation energy concentrators. Not only were such designs exceedingly heavy and expensive to manufacture, support, and control, distortions of the concentrator dish, such as dimples forming due to the imperfections in adhesion forces on the glass, reduced the efficiency of these devices. Also, when forming these dishes, the interactions between the materials themselves caused distortions to occur. Differing thermal coefficients of expansion resulted in different materials used in the dish expanding and contracting at different rates, resulting in additional distortions that varied with the temperature surrounding the dish.

Many different conventional concentrator dish formation methods were developed to address some of these concerns. In one instance a glass-foam core mirror was used to provide a support to the reflective glass surface. To create this, glass was mechanically deformed and bonded to a foamed glass support that had been previously ground to a specific contour. The thermal coefficient of expansion was addressed by using materials that had similar thermal coefficients of expansion. However, this design still resulted in a dish weight of 16,000 kg for a 10.7 meter application.

Other conventional dishes have used a method of bonding the reflective surface to a steel membrane, and then stretching the membrane and reflective surface to the desired curve. This does reduce the weight of the support structure; however the resulting shape of the membrane is not parabolic. The short-comings of a non-parabolic concentrator dish are mitigated by using multiple smaller stretched membrane discs assembled to approximate a paraboloid. But this results in significant areas in the arrangement that will not be able to collect electromagnetic radiation, thus wasting the energy that could be collected. Furthermore, the lack of a precise focal point results only in an approximation of focusing reflected energy to a focus region, which limits the level of energy concentration that can be achieved.

Another conventional dish fabrication method formed fiberglass supports over a mandrel. In this method, the mandrel was first created in the desired shape. The reflective surface and other material used to form the concentrator dish were then layered upon the mandrel, such that the inner surface of the concentrator dish was in contact with the mandrel. Over a period of time, the materials are all reshaped and molded to fit the contour specified by the mandrel. If, after forming the mandrel, it was discovered that there was a distortion in the shape, a new mandrel had to be created in order to form the dish. Also, once the mandrel was determined to be of proper shape and design, the process of molding the materials to form the concentrator dish was done slowly to reduce the likelihood of distortions appearing during the molding process. Consequently, this was a design and manufacturing technique that would be intolerable if applied to collectors to be replicated many times in an assembly-line fashion to generate electrical energy on a scale that would be useful for large numbers of people.

The manufacture of concentrators in the field is typically unwise because it is difficult to control manufacturing conditions and to maintain quality control standards. And, it usually costs far more to maintain a skilled labor force in the field. Thus, it is usually desirable to manufacture as much as possible in a factory and then merely assemble in the field, using as little field assembly as possible. Moreover, it is highly undesirable to manufacture a large number of extremely large structures, such as large-scale concentrators, using designs and manufacturing techniques that require an extremely large factory, with each concentrator being manufactured more or less in parallel with the other concentrators, and with each concentrator being manufactured at a slow pace. The costs of such a large factory space and of the supporting manufacturing tools, equipment, and jigs for a large number of collectors being manufactured in parallel would be intolerable if applied to collectors to be replicated many times in an assembly-line fashion to generate electrical energy on a scale that would be useful for large numbers of people. Accordingly, a need exists for a collector design and manufacturing technique that permits a smaller factory to quickly manufacture a single collector, and then repeat the process for additional collectors as needed. Collector designs and manufacturing techniques that promote the slow manufacturing of a single collector are unworkable when it comes to manufacturing collectors to be replicated many times in an assembly-line fashion to generate electrical energy on a scale that would be useful for large numbers of people.

### BRIEF DESCRIPTION OF THE DRAWINGS

A more complete understanding of the present invention may be derived by referring to the detailed description and claims when considered in connection with the Figures, wherein like reference numbers refer to similar items throughout the Figures, and:

FIG. 1 shows an electromagnetic energy collection device in accordance with a preferred embodiment of the present invention;

FIG. 2 shows a schematic view depicting an electromagnetic energy concentrator dish in accordance with a preferred embodiment of the present invention;

FIG. 3 shows a top-down view showing more than one sector joined to form an electromagnetic energy concentrator dish in accordance with a preferred embodiment of the present invention;

FIG. 4 shows a cross-sectional view of the sector shown in FIG. 3 in accordance with a preferred embodiment of the present invention;

FIG. 5 shows a top-down view showing more than one segment joined to form the sector in accordance with a preferred embodiment of the present invention;

FIG. 6 shows an exploded schematic view depicting a segment shown in FIG. 5 in accordance with a preferred embodiment of the present invention;

FIG. 7 shows a chart of various manufacturing stages included in a method to fabricate a segment in accordance with a preferred embodiment of the present invention; and

FIG. 8 shows a chart of various manufacturing stages included in a method to fabricate a segment in accordance with an alternative preferred embodiment of the present invention.

### DETAILED DESCRIPTION OF THE PREFERRED EMBODIMENTS

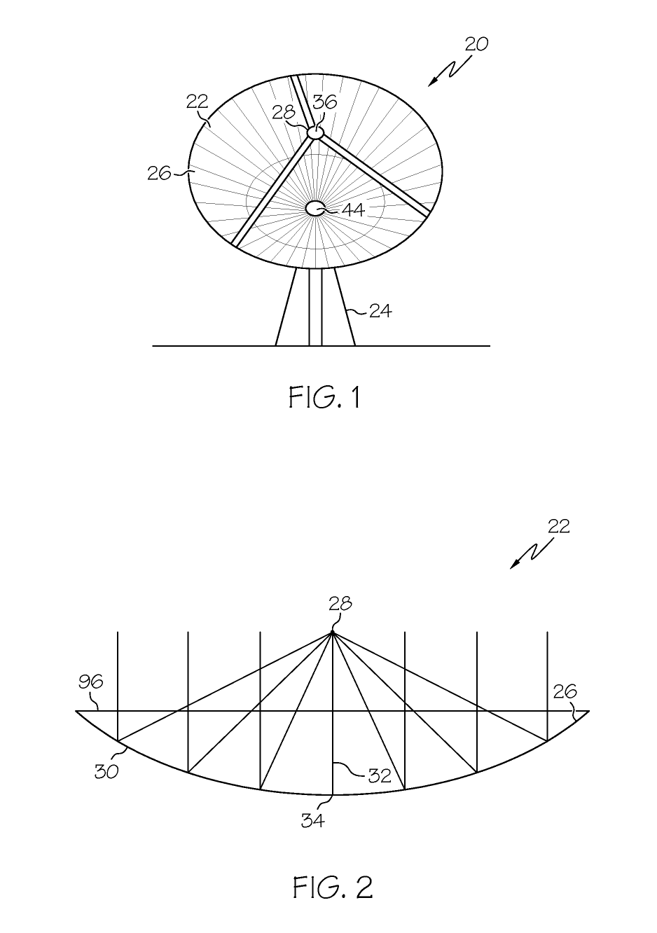

FIG. 1 is an electromagnetic energy collection device 20. Electromagnetic energy collection device 20 includes electromagnetic energy concentrator dish 22 and support structure 24. Electromagnetic energy concentrator dish 22 has a parabolic contour 26 configured to focus electromagnetic energy to a focus region 28. When concentrating solar energy, it is desirable to concentrate the energy collected to as small a focus region 28 as possible so as to concentrate the collected solar energy to many hundreds or even thousands of suns. As focus region 28 decreases in size, all other factors remaining constant, the intensity of the collected energy increases. Collecting energy at this degree of concentration increases the efficiency at which electrical energy can be created from solar energy. Energy collection is maximized when electromagnetic energy concentrator dish 22 is pointed in the direction of the source of the electromagnetic energy, as this provides the maximum amount of energy reflecting off parabolic contour 26 to focus region 28. Support structure 24 is used to position electromagnetic energy concentrator dish 22 as desired. The length and strength of support structure 24 is determined based upon whether electromagnetic energy concentrator dish 22 will be elevated above the ground, as seen in FIG. 1, or placed on the ground.

In one embodiment, electromagnetic energy concentrator dish 22 is greater than 10 meters in diameter. In a preferred embodiment, electromagnetic energy concentrator dish 22 is greater than 15 meters in diameter. This large size of electromagnetic concentrator dish 22 provides a greater area from which to collect electromagnetic energy. This results in a greater concentration of focused energy at the small focus region 28. When creating dishes of such size, the cost and time associated with forming the dish increases. The costs of materials increase, as more materials are necessary to form the dish itself. However, any support structure 24 that is used, also increases the costs. The lighter electromagnetic concentrator dish 22 is, the less weight support structure 24 must support. Lighter dishes 22 reduce the material costs both in electromagnetic concentrator dish 22 and support structure 24.

In a preferred embodiment, concentrator dish 22 is manufactured in subparts which are then assembled to form concentrator dish 22, rather than as an integrated unit. The use of subparts reduces manufacturing time and costs, and it dramatically reduces rework time and costs. This will be discussed in more detail associated with FIGS. 2-5.

FIG. 2 is a cross-sectional view of an electromagnetic energy concentrator dish 22. An inner surface 30 of electromagnetic energy concentrator dish 22 is designed to reflect electromagnetic energy to focus region 28 and has a concave contour 26 that is shaped to be as close to a “perfect” parabola with no distortions as is reasonably possible. This is because the shaped contour of an ideal paraboloid is able to reduce focus region 28 to the smallest region possible with minimal distortion. Thus, there is only one small area, focus region 28, through which any wave reflected off any part of inner surface 30 passes. Focus region 28 is located at a distance 32 from a center 34 of electromagnetic energy concentrator dish 22.

Unfortunately, electromagnetic energy concentrator dish 22 may not be an ideal paraboloid due to real world manufacturing constraints. Distortions often arise during the manufacturing process, such as air bubbles and surface distortions. And, distortions may also arise during the operational life of electromagnetic energy concentrator dish 22. Such distortions affect the accuracy of electromagnetic energy concentrator dish 22 in reflecting electromagnetic energy. The defocusing of reflected electromagnetic energy by electromagnetic energy concentrator dish 22 results in focus region 28, rather than the energy being focused at a single point. Although focus region 28 is larger than would result from the use an ideal paraboloid shape, it will still be small enough such that substantially all energy reflected will be collected at a receiver 36 (FIG. 1). Receiver 36 is configured to collect reflected electromagnetic energy, and convert the reflected energy into another form, such as heat, electricity, audible or visual signals, and the like. This can be done by heating a transport medium, such as air, or water, photovotaics, or by having other components that will demodulate the collected electromagnetic energy into audible or visual signals. Receiver 36 is placed at focus region 28. However, it is desirable to have a smaller focus region 28, as a greater intensity and concentration of reflected energy can be obtained with a smaller focus region 28. Therefore, contour 26 should be accurately determined so that electromagnetic energy can be efficiently collected in spite of inevitable manufacturing distortions and distortions that develop over time.

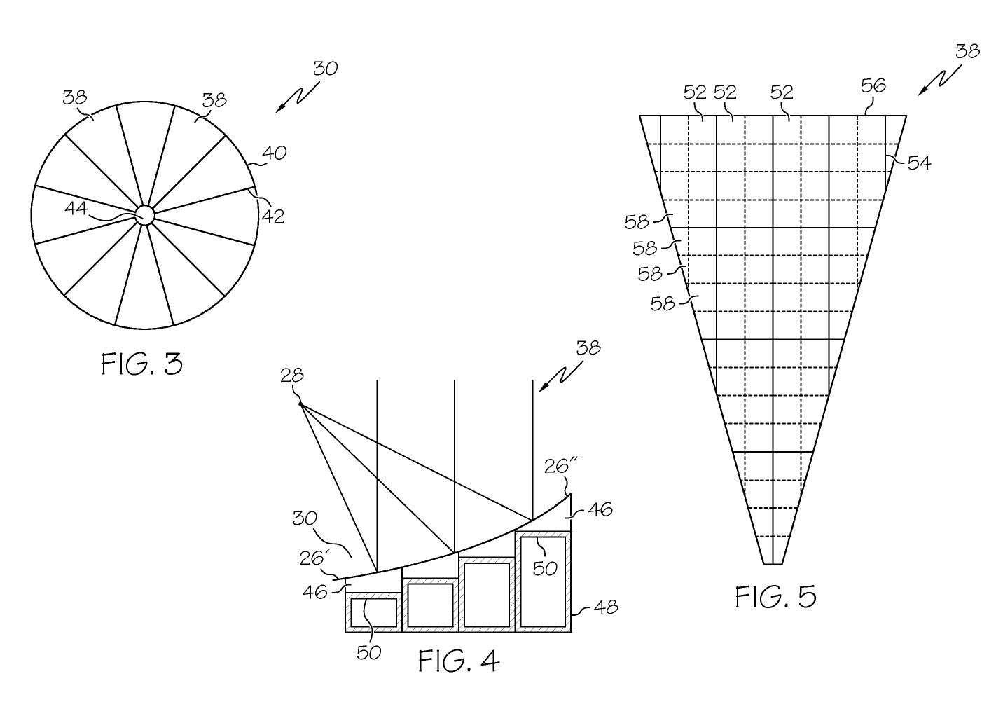

FIG. 3 is a top view of electromagnetic energy concentrator dish 22, showing inner surface 30 of electromagnetic energy concentrator dish 22. Electromagnetic energy concentrator dish 22 is sectioned into sectors 38. Each sector 38 has an arc length 40 and a radius 42. As contour 26 of electromagnetic energy concentrator dish 22 is substantially paraboloid, radius 42 of each sector is substantially the same. In one embodiment, each arc length 40 of each sector 38 is substantially the same. Thus, all sectors 38 are substantially equal in size and shape in the preferred embodiment from the top-view perspective of FIG. 3. When all sectors 38 are substantially equal, the contour 26 (FIG. 2) that will focus the electromagnetic energy has to be determined only for one sector 38. Thus, once contour 26 is determined, sector 38 can be replicated as many times as necessary to produce as many electromagnetic energy concentrator dishes 22 as desired.

As electromagnetic energy concentrator dish 22 is a paraboloid, and thus has radial symmetry, when all sectors 38 are substantially equal in size and shape, contour 26 for inner surface 30 in one sector 38 is the same as contour 26 for each other sector 38. Thus, the treatment of inner surface 30, discussed below, which produces contour 26 in inner surface 30 for one sector 38 can be duplicated for all sectors 38 to simplify, speed up, and reduce costs in the manufacturing process.

In one embodiment, there is an area 44 (FIG. 1) in the center of electromagnetic energy concentrator dish 22 which would often be blocked by, or in the shadow of, receiver 36. Therefore, in order to reduce the costs of production and the weight of energy concentrator dish 22, structure in area 44 may be omitted from the fabrication of electromagnetic energy concentrator dish 22. If this is the case, contour 26 (FIG. 2) need not be determined for area 44 because little electromagnetic energy reaches area 44.

When support structure 24 is configured to elevate electromagnetic energy concentrator dish 22 a distance above the ground, as seen in FIG. 1, it is desirable to have electromagnetic energy concentrator dish 22 somewhat balanced across support structure 24. When electromagnetic energy concentrator dish 22 is aimed in a nearly horizontal direction, if electromagnetic energy concentrator dish 22 is not balanced, the full weight of electromagnetic energy concentrator dish 22 would be entirely on one side of support structure 24. In one embodiment, at least one sector 38 is removed from electromagnetic energy concentrator dish 22 to allow a portion of support 24 to reside in front of inner surface 30 while in this position and to adjust the center of gravity for dish 22 so that balance across support structure 24 can be maintained. By better distributing the weight of concentrator dish 22 while aimed in a nearly horizontal position, the strength of support 24 may be considerably reduced, with a corresponding reduction in cost. In one embodiment, the cost advantages in weight distribution and adjustability of electromagnetic energy concentrator dish 22 having at least one sector 38 removed are greater than the revenue generated by the energy concentration from the removed sector 38.

In another embodiment, all sectors 38 are fabricated and assembled to collect electromagnetic energy. This can be done either when electromagnetic energy concentrator dish 22 is installed on the ground, or when support structure 24 has sufficient strength to support all sectors of electromagnetic energy concentrator dish 22 even when aimed in a nearly horizontal direction. The assembly of all sectors 38 provides more reflected electromagnetic energy, thus increasing the efficiency of electromagnetic energy concentrator dish 22.

FIG. 4 is a cross-sectional view of a portion of a sector 38. FIG. 4 shows that inner surface 30 of sector 38 is a portion of a parabola with a contour 26′, such that reflections of electromagnetic energy can be collected within focus region 28. A contoured support 46 is used to support inner surface 30 in the desired substantially parabolic shape. Contoured support 46 has a substantially flat base to permit ease of attachment to a frame 48. Frame 48 has substantially flat arms 50 that provide a surface upon which contoured support 46 is attached.

FIG. 5 is a top view of a sector 38. In this embodiment, sector 38 is sectioned into a plurality of segments 52. Although sector 38 has quadrilateral and triangular segments 52, all segments are formed from cutting rectangular segments to fit within its allotted position sector 38. Each rectangular segment 52 has a length 54 and width 56. In one embodiment, each length 54 and width 56 of each segment 52 is substantially the same. Thus, all rectangular segments 52 are substantially equal in size. Length 54 and width 56 can be varied based upon the desired size of electromagnetic energy concentrator dish 22. In one embodiment, rectangular segments 52 are a standard size of 4′×8′, such that costs are reduced due to the use of common size, off-the-shelf materials.

Each segment 52 has a specific contour 26″ (FIG. 4) that will ensure that electromagnetic energy will reflect back to focus region 28. Contour 26″ is unique to each segment 52 given the location of each segment 52 within sector 38.

Contours 26″ are determined based upon the length 54 and width 56 of segment 52, and the position of segment 52 within sector 38. In the preferred embodiment, each contour 26″ is a three-dimensionally, continuously curved surface that substantially omits singularities, and that is configured to simulate that portion of a paraboloid that corresponds to the position of segment 52 within electromagnetic energy concentrator dish 22. In any one sector 38, no two segments 52 will have the exact same contour 26″ (FIG. 2). This is because both the radial angle and vertical angle for reflection will change based upon the position of segment 52 within sector 38. However, if all sectors 38 are substantially the same, once one sector 38 is fabricated, it can be duplicated for all sectors 38, and when assembled, substantially all electromagnetic energy will reflect to focus region 28. A segment 52, outlined with solid lines in FIG. 5, may be further divided into sub-segments 58, outlined in dotted lines in FIG. 5. Sub-segment 58 divisions may be used to more precisely place and align components of segment 52 to ultimately focus the reflected electromagnetic energy to focus region 28.

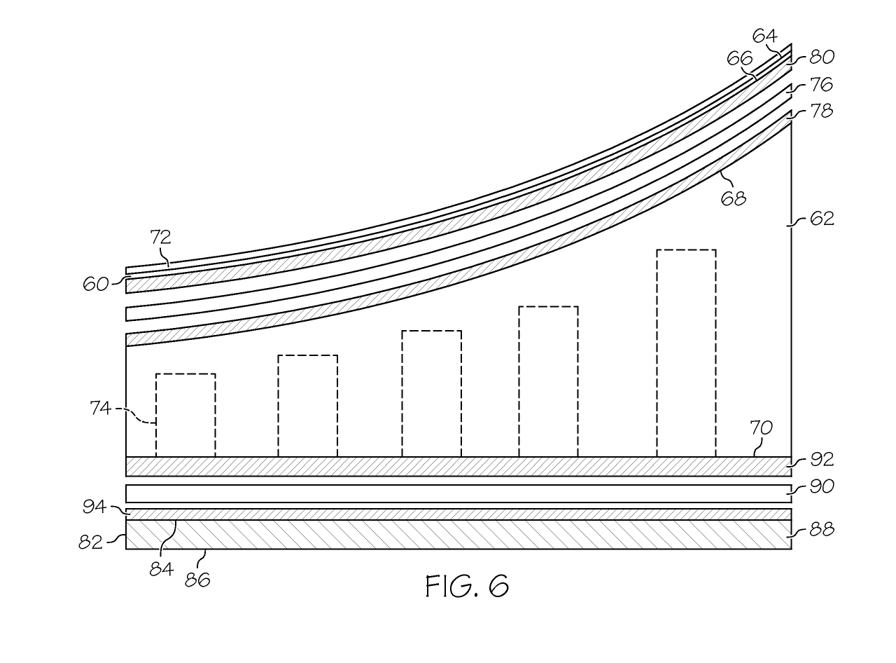

FIG. 6 is an exploded cross-sectional view of segment 52. Although each segment 52 in each sector 38 has a unique contour 26″, the structure of segment 52 as shown in FIG. 6 is found in all segments 52 of electromagnetic energy concentrator dish 22. Segment 52 includes a reflective surface 60 and a contoured polymeric support 62. Reflective surface 60 has a front side 64 that is configured to reflect electromagnetic energy, and a back side 66 that is placed upon contoured polymeric support 62. When placed upon contoured polymeric support 62, reflective surface 60 will conform to the contour of contoured polymeric support 62. The resulting contour of reflective surface 60 changes the angle at which electromagnetic energy is reflected throughout surface 60. Contoured polymeric support 62 has a contoured surface 68 (discussed below) and a substantially flat surface 70 and comprises a polymeric material. Contoured polymeric support 62 serves as contoured support 46 in FIG. 4 while also reducing the weight of segment 52 (discussed further below). The properties of a material determine what wavelengths the material will absorb and what wavelengths it will reflect. Therefore, the material from which reflective surface 60 is manufactured determines what sort of electromagnetic energy reflective surface 60 will reflect. In one embodiment, reflective surface 60 is a back-surface silvered glass. Ideally, electromagnetic energy would pass through the atmosphere (not shown), come in contact with reflective surface 60, and reflect to focus region 28 (FIG. 1). However, this would leave reflective surface 60 open to the elements, exposing reflective surface 60 to corrosion and other damaging effects. The addition of a protective layer 72, such as glass or any other material on front side 64 of reflective surface 60 will help counteract these effects of nature. However, protective layer 72 may alter the incident and reflective angles to reflective surface 60. The effects of this alteration can be reduced by accounting for the refraction when determining the contour 26 (FIG. 2) needed for the segment 52. Also, reducing the thickness of protective layer 72 will reduce the effects of refraction while also reducing the weight of electromagnetic energy concentrator dish 22. Furthermore, reducing the thickness of protective layer 72 will also increase the flexibility of protective layer 72 such that protective layer can more easily conform its shape to its respective contour 26″. In one embodiment, protective layer 72 is a glass with a thickness of less than 4 mm.

In order to focus electromagnetic energy reflections from segment 52 to focus region 28, reflective surface 60 is placed on contoured polymeric support 62 that has contour 26″. In one embodiment, contoured polymeric support 62 is formed from a dimensionally stable foam. Having a dimensionally stable foam provides a support for reflective surface 60 that can hold contour 26″over the life of electromagnetic energy concentrator dish 22. Polymeric foam is used to reduce the weight of segment 52 and electromagnetic energy concentrator dish 22 while also reducing the costs both in the acquisition of contoured polymeric support 62 and in working contoured polymeric support 62.

Contoured polymeric support 62 is machined such that contoured surface 68 of contoured polymeric support 62 matches contour 26″ that was previously calculated as precisely as is reasonably possible. In one embodiment, the machining process use a conventional industrial router (not shown) attached to a computer numerical control (CNC) machine (not shown). The positioning of a cutting head of the router is controlled in three dimensions by a computer. The adjustments for the depth of contoured polymeric support 62 are minimal due to the gentle curvature of electromagnetic energy concentrator dish 22 over any single segment 52. By using a CNC machine to contour contoured polymeric support 62, a greater degree of accuracy and precision is attained when cutting contour 26″. The use of a polymeric material for support 62 allows the machining operation to be completed rapidly. Furthermore, once the proper contour parameters are provided to the CNC machine, the machine can produce multiple copies of the same contour 26″ in multiple different contoured polymeric supports 62 in a short period of time.

As it is desirable to reduce the weight of energy concentrator dish 22, polymeric foam is used. In one embodiment, the polymeric foam used for contoured polymeric support 62 has a density of less than 1 g/cm3. In a preferred embodiment, the polymeric foam used has a density of less than 0.5 g/cm3. The structure of the polymeric foam provides a rigidity that will give proper support to reflective surface 60, while still being strong enough to be fastened to frame 48 (FIG. 4). The low density of the polymeric foam reduces the weight that will be placed on frame 48 and support structure 24 and also the loads that will be exerted on the joints between frame 48 and contoured polymeric support 62. In one embodiment, the weight of contoured polymeric support 62 is further reduced by creating voids or pockets 74 within the polymeric foam. By structuring pockets 74 such that they do not fall on points at which contoured polymeric support 62 is attached to frame 48, the structural integrity of contoured polymeric support 62 is not significantly reduced while weight and material costs will be reduced.

An adhesive 76 is used to attach reflective surface 60 to contoured polymeric support 62. Adhesive 76 is applied to contoured surface 68 of contoured polymeric support 62 and to back side 66 of reflective surface 60, such that protective layer 72 is distal from adhesive 76.

Every material has a thermal coefficient of expansion which quantifies the dimensional changes of a material when it is heated or cooled. Contoured polymeric support 62 has a thermal coefficient of expansion, and reflective surface 60 may have a different thermal coefficient of expansion, due to the nature of the materials with which contoured polymeric support 62 and reflective surface 60 are made. If protective layer 72 is used, the combination of protective layer 72 and reflective surface 60 is likely to have a thermal coefficient of expansion which will be different from that of contoured polymeric support 62. To minimize the detrimental effects of the differing thermal coefficients of expansion, such as stress at the boundaries where two different materials join that often produces cracking, breaking, delaminating, and detaching over a lifetime of heating and cooling cycles, it is preferable that adhesive 76 remains compliant. This will provide a buffer between contoured polymeric support 62 and reflective surface 60. In one embodiment, adhesive 76 is an acrylic-based adhesive. To form a longer lasting bond with an acrylic-based adhesive 76 an acrylic surface treatment 78 may be painted on contoured surface 68, and a second acrylic surface treatment 80 may be painted on the back side 66 of reflective surface 60 prior to applying adhesive 76. Having these layers will reduce the effects of differing thermal coefficients of expansion. In one embodiment, adhesive 76 is a double-sided MACTac® branded acrylic adhesive manufactured by MACTac Printing Products.

In one embodiment, segment 52 also includes a substrate 82. Substrate 82 provides a substantially flat surface to which frame 48 (FIG. 4) can be attached while also providing a rigid base that aids in preserving the three-dimensional shape of segment 52 over its lifetime. In one embodiment, substrate 82 has a top surface 84, a bottom surface 86, and a network of transverse members 88 extending between top surface 84 and bottom surface 86. In one embodiment, network of transverse members 88 has a hexagonal, or honeycomb, structure and is made from aluminum. Network of transverse members 88 is designed to evenly distribute the forces exerted on network of transverse members 88 from top surface 84 and bottom surface 86 throughout its body. The substantially flat surface 70 of contoured polymeric support 62 is attached to substrate 82. An adhesive 90 is used to attach contoured polymeric support 62 to substrate 82. Substrate 82 may have a different thermal coefficient of expansion than that of contoured polymeric support 62. It is preferable that adhesive 90 remains compliant. In one embodiment, an acrylic surface treatment 92 may be painted upon the substantially flat surface 70 of contoured polymeric support 62, and a second acrylic surface treatment 94 may be painted on a mating surface of substrate 82 prior to placing adhesive 90 to aid in the adhesion, and to provide a greater buffer to reduce the effects of differing thermal coefficients of expansion.

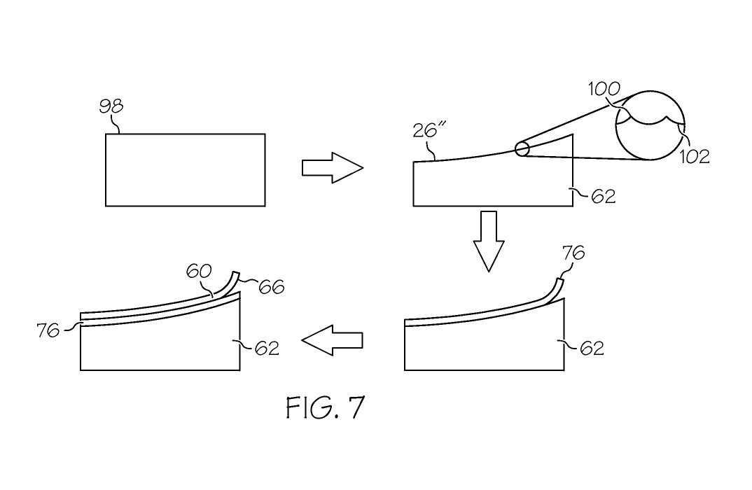

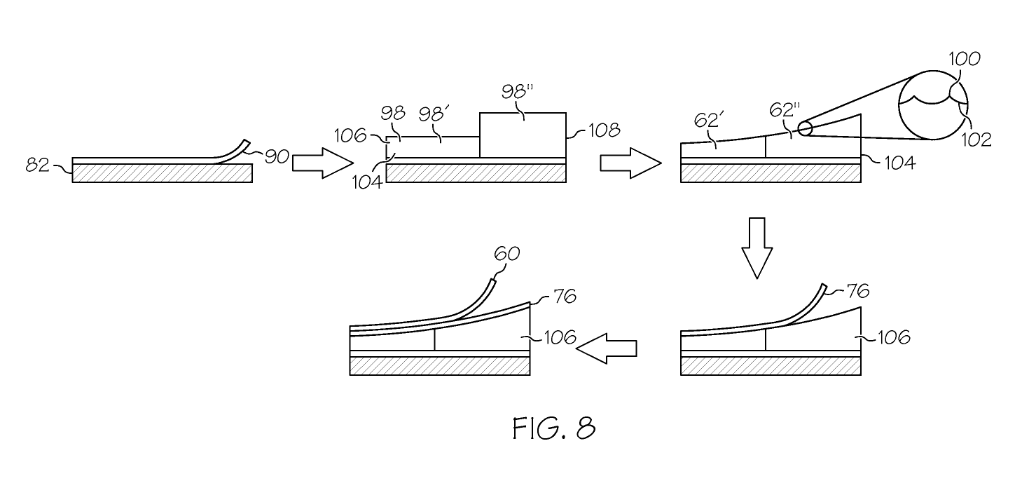

FIGS. 7-8 show various stages in a process for manufacturing two alternate embodiments of segment 52. However, prior to the actual fabrication of segment 52, contour 26″ is determined. Referring back to FIGS. 2 and 3, contour 26 (FIG. 2) is calculated prior to fabricating electromagnetic energy concentrator dish 22. To calculate contour 26, diameter 96 (FIG. 2) first determined. Based upon diameter 96, distance 32 (FIG. 2) of focus region 28 can be calculated.

Once distance 32 of focus region 28 has been fixed, contour 26 (FIG. 2) is calculated. The calculation of contour 26 involves calculating the angle of reflection along the paraboloid, and creating contours 26″ for individual segments 52 to facilitate the proper angle. A cross-sectional view of contour 26 is a parabola and a top-view is a regular polygon, similar to the depictions shown in FIGS. 1 and 2 respectively. Based on contour 26 of electromagnetic energy concentrator dish 22, contours 26″ are determined for sectors 38 that, when combined will form electromagnetic energy concentrator dish 22. If sectors 38 are substantially equal, one sector 38 may be fabricated multiple times and the multiple sectors 38 may be assembled to form electromagnetic energy concentrator dish 22.

FIG. 7 shows a chart of various manufacturing stages included in a process for the formation of a single segment 52. Once contour 26″ has been determined for each sector 38, each sector 38 is broken down into segments 52. Each segment 52 is then fabricated. As stated earlier, each segment 52 in a sector 38 has a unique contour 26″. In order to create contoured polymeric support 62, a net or near net polymeric foam 98 is contoured to fit the required contour 26″ determined for a given segment 52. In one embodiment, net or near net polymeric foam 98 is molded having contour 26″ of segment 52 or another contour that approximates contour 26″, but with foam 98 being slightly thicker than needed. This net or near net foam 98 will soon be machined to improve the accuracy at which contour 26″ is presented in foam 98 in a preferred embodiment. By using a net or near net polymeric foam 98, the amount of material that is cut away from polymeric foam 98 to create contoured polymeric support 62 is reduced. Time and costs are also reduced when net or near net polymeric foam 98 is used. In one embodiment, this contouring is done by providing contour data to a machine, as discussed above, and then machine contouring polymeric foam 98. In this embodiment, as the machine is contouring polymeric foam 98, there may be a pattern of peaks 100 and valleys 102 (FIG. 8) that is imprinted into the contoured surface 68 as a natural result of moving a cutting head over foam 98 during the machining process. Peaks 100 and valleys 102 provide extra relief when contoured polymeric support 62, adhesive 76 or reflective surface 60 expand or contract.

After polymeric foam 98 has been contoured, one side of a double-sided adhesive 76 is placed on contoured surface 68. But in one embodiment, after polymeric foam 98 has been contoured, acrylic surface treatment 78 (FIG. 6) may be first painted on contoured surface 68, and adhesive 76 is placed on acrylic surface treatment 78. The back side 66 of reflective surface 60 is placed against the other side of adhesive 76, such that reflective surface 60 has the same contour 26 as contoured surface 68 of contoured polymeric support 62. The large size of electromagnetic energy concentrator dish 22 results in a shallow, gentle curve as contour 26″ for any one segment 52, which reflective surface 60 can conform to due to the thinness of protective layer 72. In one embodiment, an acrylic surface treatment 80 (FIG. 6) is first painted on the back side 66 of reflective surface 60, and then adhesive 76 is placed on acrylic surface treatment 80. Once reflective surface 60 has been affixed to contoured polymeric support 62, segment 52 is positioned and affixed to frame 48.

FIG. 8 shows a chart of various manufacturing stages included in an alternative embodiment of assembly for segment 52. In this embodiment, substrate 82 is used to affix segment 52 to frame 48. Here, one side of a double-sided adhesive 90 is applied to substrate 82 and net or near net polymeric foam block 98 is affixed to substrate 82, forming a polymeric foam-substrate unit 104. In one embodiment, at least two polymeric foam blocks 98′ and 98″ are affixed to substrate 82. One of the polymeric foam blocks 98′ has a height 106 that is less than a height 108 of a second block 98″. By varying the heights of polymeric foam blocks 98′ and 98″ the amount of material that will be wasted while contouring polymeric foam blocks 98′ and 98″ is reduced. In one embodiment, an acrylic surface treatment 92 (FIG. 6) is first applied to substrate 82, and then adhesive 90 is placed on acrylic surface treatment 92. Polymeric foam-substrate unit 104 is then contoured to fit contour 26″ using contouring techniques described earlier.

In the embodiment of multiple polymeric foam blocks 98′ and 98″ depicted in FIG. 8, contouring polymeric foam-substrate unit 104 creates contoured polymeric supports 62′ and 62″. Contouring polymeric foam-substrate unit 104 achieves greater accuracy and precision in the resulting contour 26″ by permitting the contouring of polymeric foam blocks 98′ and 98″ as a single polymeric foam block 98 while reducing material waste resulting from the contouring process. After the polymeric foam-substrate unit 104 has been contoured, one side of a second double-sided adhesive 76 is placed on contoured surface 68, and reflective surface 60 is placed on the second double-sided adhesive 76, affixing reflective surface 60 to contoured polymeric support 62. This segment 52 is then positioned and affixed to frame 48.

In summary, the present invention teaches an electromagnetic energy concentrator dish 22 that comprises multiple segments 52, each segment 52 having a reflective surface 60 and a contoured polymeric support 62. Each contoured polymeric support 62 is uniquely contoured to reflect contour 26 of a portion of a paraboloid such that when multiple segments 52 are assembled on a frame 48, a paraboloid electromagnetic energy concentrator dish 22 is formed. Reflective surface 60 is configured to conform to contour 26 of contoured polymeric support 62 when laid upon the contoured surface 68 of contoured polymeric support 62.

Adhesive 76 is used to attach reflective surface 60 and contoured polymeric support 62. Adhesive 76 remains compliant to mitigate the effects of differing thermal coefficients of expansion of the two components.

Electromagnetic energy concentrator dish 22 may also comprise a substrate 82 upon which contoured polymeric support 62 is affixed using adhesive 90. Adhesive 90 has a thermal coefficient of expansion that is between that of substrate 82 and contoured polymeric support 62.

Although the preferred embodiments of the invention have been illustrated and described in detail, it will be readily apparent to those skilled in the art that various modifications may be made therein without departing from the spirit of the invention or from the scope of the appended claims.

What is claimed is:

1. A method of constructing an electromagnetic energy concentrator (22) comprising:
determining a contour (26) for the electromagnetic energy concentrator (22);
contouring a polymeric foam (98) to the contour (26), to form a contoured polymeric support (62); and
attaching a reflective surface (60) to the contoured polymeric support (62).

2. The method as claimed in claim 1, further comprising:
attaching the polymeric foam (98) to a substrate (82) prior to the contouring activity.

3. The method as claimed in claim 2, wherein the polymeric foam (98) comprises at least two polymeric support blocks (98′ & 98″).

4. The method as claimed in claim 3, wherein:
a first (98′) of the at least two support structure blocks (98′ & 98″) has a first height (106);
a second (98″) of the at least two support structure blocks (98′ & 98″) has a second height (108); and
the first height (106) is less than the second height (108).

5. The method as claimed in claim 3, wherein the contouring activity further comprises:
machining the at least two polymeric support blocks (98′ & 98″);
wherein the machining activity comprises:
cutting a first portion of the contour (26″) into the first (98′) of the at least two support structure blocks (98′ & 98″) to form a first (62′) of at least two contoured polymeric supports (62′ & 62″); and
cutting a second portion of the contour (26″) into the second (98″) of the at least two support structure blocks (98′ & 98″) to form a second (62″) of at least two contoured polymeric supports (62′ & 62″);
wherein the at least two contoured polymeric supports (62′ & 62″) form the contoured polymeric support (62).

6. The method as claimed in claim 1, wherein the contouring activity creates a peak (100) and valley (102) on a contoured surface (68) of the contoured polymeric support (62).

7. A method of constructing an electromagnetic energy collection dish (22) comprising:
determining a contour (26″) for each of a plurality of electromagnetic energy collection segments (52);
fabricating the plurality of electromagnetic energy collection segments (52) to exhibit the contour (26″);
combining the plurality of electromagnetic energy collection segments (52) to form an electromagnetic energy collection sector (38); and
combining a plurality of the electromagnetic energy collection sectors (38) to form the electromagnetic energy collection dish (22).

8. The method as claimed in claim 7, wherein each of the plurality of electromagnetic energy collection sectors (38) has substantially the same contour (26′).

9. The method as claimed in claim 7, wherein each of the plurality of electromagnetic energy collection sectors (38) has substantially the same shape.

10. The method as claimed in claim 7, wherein each of the plurality of electromagnetic energy collection sectors (38) has substantially the same arc length (40) and radius (42).

11. The method as claimed in claim 7, wherein the fabricating activity comprises:
attaching a polymeric foam (98) to a substrate (82);
contouring the polymeric foam (98) to the contour (26″), forming a contoured polymeric support (62); and
attaching a reflective surface (60) to the contoured polymeric support (62).

12. A method of constructing an electromagnetic energy concentrator (22) comprising:
determining a contour (26) for the electromagnetic energy concentrator (22);
providing a planar substrate (82);
coupling a polymeric foam (98) to the planar substrate (82), the substrate (82) establishing a rigid base upon which the polymeric foam (98) is supported;
contouring the polymeric foam (98) that is coupled to the substrate (82) to the contour (26) to form a contoured polymeric support (62); and
coupling a reflective surface (60) to the contoured polymeric support (62).

13. The method as claimed in claim 12, wherein the determining a contour (26) further comprises determining a unique contour (26″) for each of a plurality of segments (58) that collectively define the electromagnetic energy concentrator (22).

14. The method as claimed in claim 13, wherein the providing a planar substrate (82) further comprises providing a planar substrate (82) for each of the plurality of segments (52).

15. The method as claimed in claim 13, wherein the coupling a polymeric foam (98) to the planar substrate (82) further comprises coupling a plurality of support structure blocks (98′ & 98″) to the planar substrate (82).

16. The method as claimed in claim 15, wherein the contouring the polymeric foam (98) further comprises contouring each of the plurality of support structure blocks (98′ & 98″), such that the plurality of support structure blocks (98′ & 98″) form the unique contour (26″) of the corresponding segment (52) of the plurality of segments (52).

17. The method as claimed in claim 16, wherein each of the segments (52) is arranged in the electromagnetic energy concentrator (22), such that the unique contour (26″) of each of the segments (52) defines the contour (26) to form the contoured polymeric support (62).

18. The method as claimed in claim 17, further comprising coupling each of the planar substrates (82) to a frame (48), wherein the frame (48) further comprises stepped arms (50), and the coupling each of the planar substrates (82) to the frame (48) further comprises coupling each of the planar substrates (82) to a corresponding stepped arm (50), such that the reflective surface (60) coupled to the contoured polymeric support (62) is collectively supported step-wisely by the plurality of planar substrates (82).

19. The method as claimed in claim 12, wherein the planar substrate (82) further comprises reinforcement members (88) extending between a top surface (84) and a bottom surface (86) of the substrate (82).

20. The method as claimed in claim 15, the coupling a polymeric foam (98) to the planar substrate (82) further comprising:
adhering the plurality of support structure blocks (98′ & 98″) to the planar substrate (82) by application of an adhesive layer (90) between the support structure blocks (98′ & 98″) and the planar substrate (82);
placing a surface treatment (92) between the support structure blocks (98′ & 98″) and the adhesive (90);
placing a second surface treatment (94) between the adhesive (90) and the planer substrate (82).
